(19) United States
(12) Patent Application Publication
(10) Pub. No.: US 2006/0141342 A1
(43) Pub. Date: Jun. 29, 2006

(54) HEAT DISSIPATING VENT CAP FOR BATTERY

(76) Inventors: David Marconi, Claremont, Ontario (CA); Glen Marconi, Scarborough, Ontario (CA); David Cormack, Brampton (CA)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 10/905,273

(22) Filed: Dec. 23, 2004

(51) Int. Cl. H01M 2/12; H01M 10/48

(52) U.S. Cl. 429/86; 429/89; 429/91

(57) ABSTRACT

A vent cap for mounting in a fill opening of an electrochemical battery includes a hollow cap body with connected top and bottom walls and an inlet aperture adjacent one end of the bottom wall. The body forms a material holding chamber and has a vent hole spaced away from the inlet aperture. A connector is provided on the bottom wall for attachably mounting the cap body over a fill opening. Acid resisting material fills at least a substantial portion of the chamber and provides a substantial surface area on which vapors are able to condense as they cool. The cap body has a horizontal length at least three times the height that the body projects above the top surface of the battery and projects a greater distance on one side of the fill opening than on the other.

### BACKGROUND OF THE INVENTION

This invention relates to vent caps for mounting on batteries and, in particular to vent caps for mounting on a fill opening of an electrochemical or lead-acid battery.

A variety of caps for covering fill openings on the top of electrochemical and lead-acid batteries have been developed over the years. These vent caps can serve different functions, in addition to the function of providing a cover for the fill opening to prevent unwanted material from entering the battery and to help prevent the escape of electrolyte from the interior of the battery.

For example early U.S. Pat. No. 2,615,062 which issued to P. H. Craig on Oct. 21, 1952 describes a storage battery cap with a gas recombining device. This cap includes a cylindrical base member and a second cylindrical member having a domed top as well as a heat dissipating structure. A gas inlet member is mounted between the two cylindrical members and a catalyst is arranged within the second cylindrical member. Water return tubes connect the second cylindrical member to the first cylindrical member at spaced intervals about the periphery of the cylindrical members. A mass of glass wool is preferably provided above a perforated inlet plate of the cap in order to receive condensed moisture from the catalyst and to become saturated therewith, thus adding to a water trap effect.

U.S. Pat. No. 2,400,228 which issued to R. R. Franz et al in May 1946 describes an acid level indicator and electrolyte condenser for a storage battery, which device is screwed into a threaded opening in the top of the battery. The device consists of a hollow plug made of acid resistant material and having a transparent dome on top to permit a visual inspection of an indicator shaft. The indicator is a tubular shaft that fits over a stem that carries a hollow float at its lower end. This known plug or cap also has a perforated chamber located at its base that is filled with an acid resistant material such as glass wool, this material forming means for condensing vapors generated in the cell of the battery. There is also a vent for the battery cell formed in the side of the plug.

More recent U.S. Pat. No. 3,664,879 issued May 23, 1972 to B. N. Olsson teaches a vent plug or cap for an electro-chemical battery which allows electrolyte to be added to the battery without removing the plug and which includes a light transmitting rod extending through the plug and down to the level of the electrolyte in order to provide a means for checking the level of the electrolyte without removing the plug.

Service and maintenance problems for electrochemical batteries are common in a variety of situations, and such problems are particularly common with the respect to batteries used to power lift trucks. A common problem is the difficulty of properly checking and ensuring that each battery has a sufficient amount of battery fluid or electrolyte for battery operation and good battery life. Also the addition of water to a battery can be problematic and time consuming. For example, if proper care is not taken, the electrolyte can flow out of the top of the battery creating a hazard and causing undesirable conditions in a garage or maintenance facility. To explain further, if too much water is added to the battery cell, the electrolyte may expand during the recharging of the battery and leak out of the battery through the fill openings. Also unless they are somehow contained or trapped, harmful emissions can be produced by the battery recharging process and this can seriously affect the quality of the air in the charging area.

As indicated, sight glasses are already known for mounting in the top of a battery to provide a means for determining whether or not the battery has a proper amount of battery fluid but the known sight glasses are not in common use on batteries for lift trucks, for example. The known sight glasses generally consist of elongate tapered clear tubes made of a suitable plastic i.e. SAN plastic. The tube extends down from the top of the battery and into the battery fluid, assuming that the fluid is at a proper, operating level. When a person checks the battery level by looking at the top of the sight glass, which is visible on the top of the battery, if the top of the sight glass is dark or black, then the battery or that cell of the battery does not require additional water. However if the top of the sight glass is clear, this indicates the electrolyte level is too low and water must be added.

It is an object of one aspect of the present invention to provide an improved vent cap for mounting in a fill opening of an electrochemical battery, which vent cap may be made at a reasonable cost and facilitates the maintenance and increased life of the battery with which it is used.

It is an object of a further aspect of the invention to provide a vent cap for mounting on an electrochemical battery which has a low profile, hollow cap body that is particularly suitable in battery environments that require vent caps to have a low profile.

It is a further object of another aspect of the invention to provide a combination sight glass and vent cap device that not only contains acid-resisting material on which vapors from the battery can condense as they cool but also has a light transmitting sight member mounted therein for determining the electrolyte liquid level in the cell of the battery.

### SUMMARY OF THE INVENTION

According to one aspect of the invention, a vent cap for mounting in a fill opening of an electrochemical battery includes a hollow cap body having a top wall, a bottom and sidewalls connecting the bottom to the top wall. The bottom has an inlet aperture adjacent one end thereof. The cap body defines the material holding chamber and has a vent hole spaced away from the inlet aperture. A connector is arranged on the bottom for attachably mounting the vent cap on the battery and over the fill opening. The connector forms a connecting passage to permit electrolyte vapors to flow from the battery through the inlet aperture and into the cap body. Acid-resisting material fills at least a portion of the material holding chamber and provides a surface area on which vapors are able to condense as they cool before remaining gases exit through the vent hole. When the vent cap is in use on top of the battery, the cap body has a horizontal length that is at least three times the height that the cap body projects above a main top surface of the battery. The cap body projects horizontally from its respective fill opening a substantially greater distance on one side of the fill opening than on the other side thereof.

In a preferred embodiment of the vent cap there is a light transmitting rod mounted in the cap body so as to extend through the inlet aperture. This rod has a top end visible in or through the top wall of a cap body and has a length sufficient to allow a lower end section thereof to project into electrolyte liquid in a cell of the battery during use of the vent cap provided there is a sufficient amount of electrolyte fluid in the cell for proper operation of the battery.

According to a further aspect of the invention, a vent cap for mounting on an electro-chemical battery has a low-profile, hollow cap body including a top wall and a bottom wall. The cap body forms a material holding chamber and has an inlet aperture formed adjacent one end of the bottom wall and a vent hole spaced away from the inlet aperture. The cap also has a connector for mounting the cap body on top of the battery at a fill opening and this connector provides a fluid passage for fluid flow between an interior of a cap body and the battery by means of the inlet aperture. A body of acid-resisting material is arranged in the material holding chamber and has a surface area on which vapors from the battery can condense to a liquid as they cool during use of the vent cap. The cap body in use projects horizontally on one side of the fill opening a substantially greater distance than the cap body projects on the opposite side of the fill opening. The material holding chamber is located on said one side of the fill opening. The condensed liquid formed in the material holding chamber during use of the vent cap is able to drain out of the cap body through the inlet aperture.

In one preferred embodiment, the body of acid-resisting material comprises a plurality of plastic beads substantially filling the material holding chamber.

According to a further aspect of the invention, a combination sight glass and vent cap device for use on an electro-chemical battery includes a cap body having a top and a bottom and forming a material holding chamber. An inlet aperture is formed in the bottom and a vent hole is provided in the cap body to allow gas to exit from the cap body. A connector mechanism for mounting the cap body on top of the battery at a fill opening is also provided, this mechanism providing a fluid passage for fluid flow between an interior of a cap body and a battery by means of the inlet aperture. A body of acid-resisting material is arranged in the holding chamber to provide a surface area on which the vapors from the battery can condense as they cool during use of the device. A light transmitting sight member is mounted in the cap body and extends through the inlet aperture and the fluid passage. The sight member has a top end that is visible to the user when the vent cap is mounted on top of the battery and has a lower end arranged and adapted to project into electrolyte liquid in a cell of the battery during use of the device provided there is a predetermined minimum amount of the electrolyte liquid in the cell.

Preferably the device includes a vapor filtering member mounted in the cap body and covering the vent hole whereby only dry gas exits through the vent hole during use of the battery with the device.

Further features and advantage will become apparent from the following detailed description of a preferred embodiment of a vent cap taken in conjunction with the accompanying drawings.

### BRIEF DESCRIPTION OF THE DRAWINGS

FIG. 1 is a sectional elevation of a vent cap constructed in accordance with the invention mounted in a fill opening of a battery, the section of the vent cap being taken along the line I-I of FIG. 3;

FIG. 2 is a perspective view of a main or lower body section of a cap body of the vent cap of FIG. 1, this view showing the open top and the curved, wide end of this section;

FIG. 3 is a bottom view of the main body section of FIG. 2;

FIG. 4 is another perspective view of the main body section of FIGS. 2 and 3, this view showing the open top and the bayonet-type connector;

FIG. 5 is a perspective view of a top section of the preferred vent cap of FIG. 1, this view showing its top side and narrow end;

FIG. 6 is another perspective view of the top section of the cap body, this view showing its bottom side and its wide semi-circular end;

FIG. 7 is a longitudinal cross-section of the top section of the cap body; and

FIG. 8 is a perspective view of the assembled vent cap, this view being taken from below and from its wide semi-cylindrical end.

### DETAILED DESCRIPTION OF THE PREFERRED EMBODIMENT

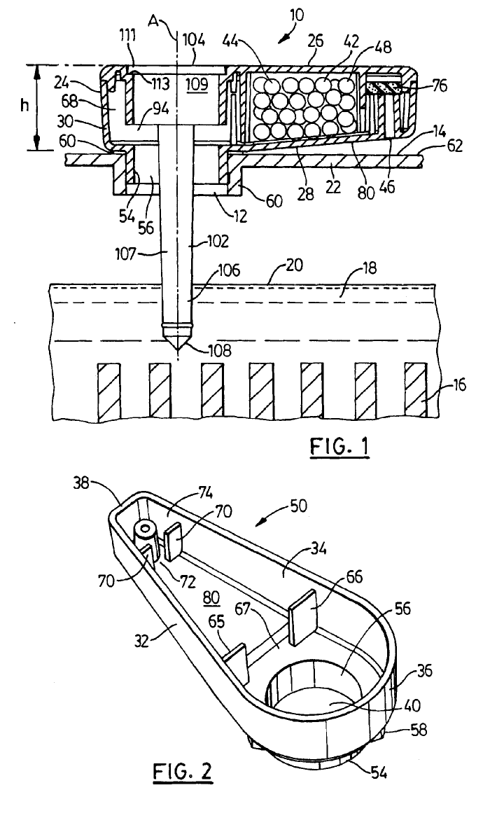

A vent cap 10 constructed in accordance with the invention is shown in FIG. 1 mounted in a fill opening 12 of an electrochemical battery 14, such as a lead-acid battery. A standard electric storage battery 14 comprises a number of lead plates 16 immersed in a liquid electrolyte 18, the surface level of which is indicated at 20. The battery housing, which is made with a rigid, acid resistant material includes a cover or top 22. Only a portion of the battery is shown in FIG. 1 and it will be understood that the battery itself is of standard construction and does not itself form part of the invention. Accordingly a further detailed description of the battery is deemed unnecessary.

It will be understood that typically such batteries must be recharged from time-to-time using battery charging equipment. Also it is necessary to replenish the water in the battery from time-to-time and this is done through the fill openings formed in the battery cover 22. The level of the electrolyte in the battery must be maintained above a certain minimum level and generally above the top of the lead plates 16 for the proper operation of the battery and for maintaining battery life.

The illustrated preferred vent cap 10 has a hollow cap body 24 which includes a top wall 26, a bottom 28 and sidewalls indicated generally at 30. In the illustrated preferred embodiment, the sidewalls 30 include straight sections 32 and 34 located on opposite sides of the cap body, substantially semi-cylindrical end wall 36 connecting the two straight sections, and a relatively small end wall 38 which also connects the two straight sections.

The bottom of the cap body has an inlet aperture 40 adjacent one end of the bottom and in particular the wider end defined by end wall 36. As explained in more detail hereinafter, the cap body defines a material holding chamber 42, the vertical walls of which extend down from the top wall of the cap body and acid-resisting material fills at least a portion, preferably a substantial portion of the material holding chamber 42 and this material is indicated at 44. This material provides a surface area, preferably a substantial surface area, on which electrolyte vapors are able to condense as they cool before remaining gases exit through a vent hole 46. Although the acid-resisting material can take a variety of forms including a plastic mesh, in a preferred embodiment this material comprises a plurality of small plastic beads 48 that substantially fill the chamber 42. Although the preferred beads are spherical in shape, clearly other shapes are possible including elongate, oval shaped beads and beads having an irregular shape.

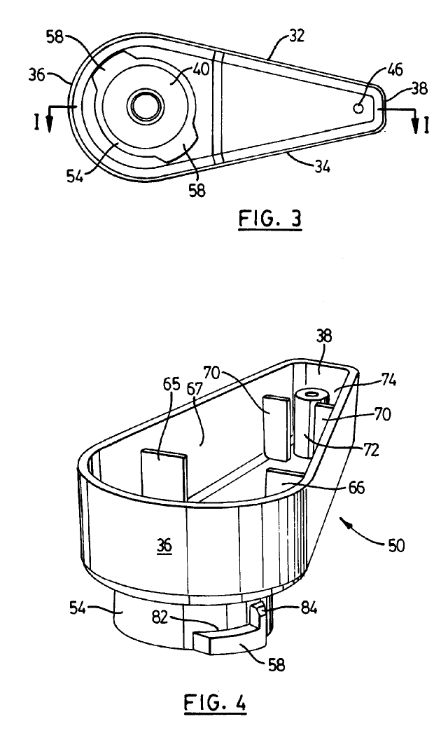

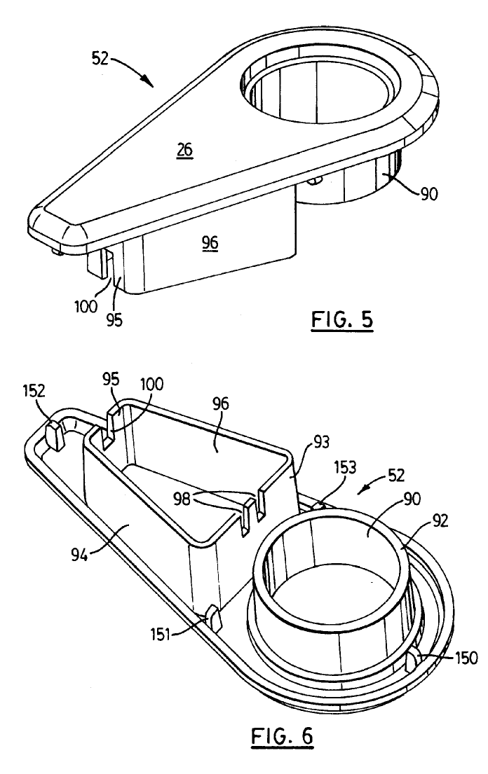

The preferred vent cap is constructed from the assembly of two plastic sections including a main body section 50 illustrated in FIGS. 2 to 4 which forms or provides the aforementioned bottom 28 and sidewalls 30 and a top section 52 illustrated in FIGS. 5 to 7 which provides the aforementioned top wall 26. These two principal sections can be connected together in a variety of known ways including the use of a suitable adhesive. A preferred method of attachment however is by welding their adjacent edges together and, in particular by sonic welding.

The vent cap 10 also includes a connector 54 which is arranged on the bottom 28 of the main body section 50. The purpose of the connector is to detachably mount the vent cap on the battery 14 and over the fill opening 12. The connector forms a connecting passage at 56 to permit electrolyte vapors to flow from the battery, through the inlet aperture 40, and into the cap body. Although a variety of connecting mechanisms are possible (including a thread connection), the use of which is dependent to some extent on the construction of the section of the battery top forming the fill opening, the illustrated preferred connector is a bayonet-type connector having two bayonet connecting flanges 58 located on opposite sides of the connector. This connector has a cylindrical section that is integrally formed on the main body section or bottom section 50 and the bayonet connecting flanges are integrally formed on the outer surface of this cylindrical section. It will be understood that the cylindrical section 60 of a battery cover 22 that forms the fill opening is formed with two bayonet slots or recesses that are sized and adapted to receive the bayonet connecting flanges 58. After an initial downward movement of the cap body whereby the connector is inserted into the fill opening, the cap body can then be turned about a vertical axis to engage the bayonet connecting flanges in their respective slots or recesses, thereby securing the vent cap in the fill opening of the battery.

As can be seen in FIGS. 4 and 8, each flange 58 is preferably formed with a gently sloping upper surface 82. It will be appreciated that the downward slope is in the direction that the cap body is turned about the axis A to secure the vent cap on the fill opening. However rotational movement of the cap body is limited by a short, vertical stop 84 formed at the thicker end of the flange 58. In one preferred embodiment the minimum vertical thickness of the flange is 3.5 mm and the thickness increases to 4.25 mm to the stop 84 which itself has a height of 1.75 mm.

In one preferred form of the connector, the cylindrical section has a height H indicated in FIG. 8 which is 8 mm and the maximum width of each connecting flange 58 is 12 mm. The passage 56 through the connector in this embodiment has a diameter of 20 mm. Preferably a rubber or rubber like washer 60 is mounted on the connector for sealing a joint between the top surface of the battery and the connector. The washer should be made of an acid-resistant material.

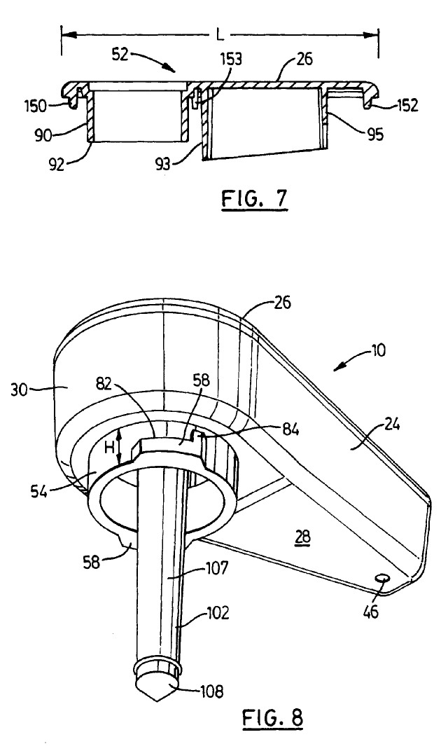

As illustrated in FIG. 1, the preferred vent cap 10 ha a low-profile hollow cap body 24 which makes it ideal for many battery uses including batteries on forklift trucks. It will be appreciated that often there is very low clearance between the top of batteries used in a vehicle or otherwise and a cover plate for the battery compartment or other covering surface. Thus, when the vent cap is used on top of a battery as shown in FIG. 1, the cap body has a horizontal length (indicated at L in FIG. 7) that is at least three times the height that the cap body projects above a main top surface 62 of the battery. In one particular preferred embodiment the overall length L of the cap body is 75 mm. while the height h of the cap body is approximately 17 to 20 mm. Preferably the cap body projects above the adjacent top surface of the battery a distance of no more than 30 mm, more preferably no more than 25 mm. The cap body projects horizontally from its respective fill opening 12 a substantially greater distance on one side of the fill opening than on the other side thereof as can be clearly seen from FIG. 1. A further advantage of this, apart from providing the necessary chamber for the acid-resisting beads 48, is that the long projecting side of the cap body provides a form of lever arm, making it easy for the user to pivot the vent cap about its vertical axis indicated at A.

Turning now to the preferred construction of the main body section or lower section 50, in addition to the exterior walls already described, there are two inner partitions 65 and 66 separated by a gap 67. These partitions help to separate an initial cooling chamber 68 located above the inlet aperture 40 from a section of the cap body that forms the material holding chamber 42. The gap 67 allows vapors and gases in the cooling chamber 68 to pass into the material holding chamber. The partitions also help to strength the cap body. There are also provided two further, smaller partitions 70 which are separated by a gap 72. These partitions 70 are connected to the exterior sidewalls and each extends the height of the adjacent sidewall. Again the gap 72 permits any remaining vapors and gases that exist in the air flowing through the cap body to pass into a small end chamber 74 where the vent hole 46 is located or connected. A sponge filter 76 or other form of filter made of an acid-resistant material is mounted in the end chamber 74 and, in a preferred embodiment, substantially fills at least the top of this chamber so that any gases or vapors wishing to pass through the end chamber to the vent hole are forced to pass through the filter. Thus the air and gas flow is filtered by the sponge filter before it can exit through the vent hole. As shown in FIG. 1, preferably the inlet of the vent hole is located in an upper portion of the end chamber.

Another preferred feature of the main body section 50 is that a substantial section 80 of the bottom 28, and in particular the section located below the material holding chamber 42 and end chamber 74, slopes downwardly in the direction of the inlet aperture 40 so that, during use of the vent cap, liquid formed by condensation of the vapors on the acid-resisting material 44 is able to flow to the inlet aperture and back into the battery, thus helping to increase battery life. The same applies to the electrolyte condensate filtered out by the sponge filter 76 which can collect in the bottom of the end chamber and drain back through the chamber 42.

Turning now to further details of the preferred top section 52 illustrated in FIGS. 5 to 7, in addition to forming the top wall 26, this section has a cylindrical extension 90 that extends downwardly from the top wall 26. The circular bottom edge 92 of the cylindrical extension is spaced above the bottom of the main body section 50 as illustrated in FIG. 1. Thus a gap is formed at 94 which allows vapors rising through the aperture 40 to pass into the space formed between the cylindrical extension 90 and surrounding walls of the main body section. Extending downwardly from the top wall 26 are four interconnected walls 93 to 96 which substantially form the aforementioned material holding chamber 42. The longer walls 94, 96 converge towards one another in a horizontal direction as shown in FIG. 6 and these walls can be parallel to their respective adjacent sections 32, 34 of the sidewalls 30. The height of the walls 94, 96 decreases from one end of each wall to the other end to accommodate the sloping section of the bottom 28.

The top section 52 is preferably formed with locating tabs 150 to 153. These help to position the top section correctly on the bottom section 50 before the two sections are permanently connected. The tabs engage the inside surfaces of the sidewalls formed by the bottom section.

It will be seen that one or more openings 98 are formed in the end wall 93. In the illustrated end wall there are two of these openings 98 extending upwardly from the bottom of the wall. It will be seen that these openings are in the region of the adjacent gap 67 formed between the partitions 65, 66. Thus vapors and gas are able to flow from the initial cooling chamber and into the material holding chamber 42 which contains the beads. Another opening 100 is provided in the smaller end wall 95 so that the gas and any remaining vapors can pass from the chamber 42 into the end chamber 74. As illustrated there is only one opening 100 and it is aligned with the gap 72. In one preferred embodiment, the height of the openings 98, 100 is 6 mm in each case while the width of each opening varies from 1.75 mm in the case of the openings 98 to 2.5 mm in the case of the single opening 100.

A preferred version of the vent cap includes a light transmitting rod 102 which is mounted in the cap body 24 so as to extend through the inlet aperture 40. The rod preferably has a wide top end 104 visible in or through the top wall of the cap body and has a length sufficient to allow a lower end section 106 to project into electrolyte liquid 18 in a cell of the battery during use of the vent cap provided there is a sufficient amount of electrolyte fluid in the cell for proper operation of the storage battery. It will be appreciated that the appearance of the top end 104 of the rod indicates to a user of a vent cap whether or not there is sufficient electrolyte in the cell when the vent cap is being used on top of the battery. The preferred rod has a slight taper extending along major section 107 and it can also have a short conical end portion at 108. An integral wide head portion 109 at the top end of the rod 102 is firmly attached to the top wall 26, which has a circular opening formed therein to snuggly receive the top section. It will be appreciated that the preferred rod 102 (including portion 109) is made with a very clear, transparent plastic or glass that can withstand prolonged exposure to the electrolyte liquid and vapors.

In one preferred embodiment of the rod, the rod projects about 48 mm below the bottom of the cap body. Of course the length of the rod can vary depending upon the particular requirements of the battery with which it is to be used. Also, the head portion 109 can be formed with a circular flange 111 that rests on recessed shoulder 113.

With the use of the preferred rod 102 a so-called “clear eye” or “clear top” end 104 indicates that the battery requires additional water so that permanent damage is not done to the battery. If the top end is dark (that is it has a so-called “dark eye”), this indicates to the maintenance person that no additional water is required in the battery.

It will thus be seen that an improved vent cap 10 has been provided and because of its mode of operation, it provides a number of advantages. Firstly it will be appreciated that the construction of the preferred vent cap 10 forces gas and vapors flowing into it from the battery to turn at a right angle in order to flow through the vent cap which is a type of dissipater. Because of the path that the gases and vapors are forced to take, heat can escape from the gas and vapors which cool as they pass through the three preferred chambers. It will be understood that the first chamber, that is the initial cooling chamber 68 permits the gases and vapors to rise in the chamber where they can condensate on the top and sides of the chamber. Heat can dissipate through the top of the cap body 24 and into the atmosphere. When the remaining gases and vapors flow into the second chamber which is the material holding chamber 42, the gases and vapors cool further and liquid condensate forms on the surfaces of the beads 48. Eventually this moisture collects and flows back into the battery cell for further use in the battery. In the third or end chamber 74, the remaining gases flow outwardly through the sponge filter which acts to clean the gases of any remaining moisture and other foreign materials. The filter also prevents foreign matter from entering through the vent hole.

It will be further understand that with the use of the preferred vent cap described above, the dangers that arise from recharging a battery may be alleviated to a significant extent. For example, in the past, if too much water has been added to the battery cell, the electrolyte may expand during the recharging process and leak out of the battery which can cause a safety hazard. However with the use of the preferred vent cap 10, the escaping electrolyte can expand into the chambers of the vent cap thereby preventing the electrolyte from escaping onto the top of the battery. Furthermore the harmful emissions that can be generated by recharging the battery are greatly reduced. Lead, sulphuric acid, and lead oxide emissions that might normally escape during the recharging process are captured by the described vent cap and they are allowed to flow back into the battery. In this way the air quality in the charging area may be significantly improved.

One preferred form of plastic for the cap body is polypropylene and a preferred form of plastic for the sight rod 102 is SAN plastic. If a plastic mesh is used instead of the aforementioned sponge filter 76, one suitable material for the mesh is nylon.

It will be appreciated by those skilled in the construction of batteries and vent caps that various modifications and changes can be made to the described vent cap and combination sight glass and vent cap without departing from the spirit and scope of this invention and all such modifications and changes are intended to be part of this invention. For example instead of forming a vent cap with three distinct chambers as described, it is possible to construct the vent cap with only two chambers or even with only one chamber. For example it is possible to omit the end chamber 74 if one wishes to omit the use of a final filter to remove any remaining vapors and harmful materials from the gas flow. Similarly it is possible to construct a vent cap with a single large chamber which may be substantially filled with acid resistant material such as the beads 48 provided the walls of the chamber are constructed in a manner to properly hold and capture the acid-resisting material while at the same time permitting the necessary gas and vapor flow through the chamber to a vent hole.

What is claimed is:

1. A vent cap for mounting in a fill opening of an electrochemical battery, said vent cap comprising:
a hollow cap body having a top wall, a bottom and sidewalls connecting said bottom to said top wall, said bottom having an inlet aperture adjacent one end thereof, said cap body defining a material holding chamber and having a vent hole spaced away from said inlet aperture;
a connector arranged on said bottom for detachably mounting said vent cap on said battery and over said fill opening, said connector forming a connecting passage to permit electrolyte vapors to flow from said battery, through said inlet aperture, and into said cap body; and
acid-resisting material filling at least a portion of said material holding chamber and providing a surface area on which said vapors are able to condense as they cool before remaining gases exit through said vent hole,
wherein when said vent cap is in use on top of said battery, said cap body has a horizontal length that is at least three times the height that the cap body projects above a main top surface of said battery and said cap body projects horizontally from its respective fill opening a substantially greater distance on one side of said fill opening than on the other side thereof.

2. A vent cap according to claim 1 including a light transmitting rod mounted in said cap body so as to extend through said inlet aperture, said rod having a top end visible in or through said top wall of the cap body and having a length sufficient to allow a lower end section thereof to project into electrolyte liquid in a cell of said battery during use of said vent cap provided there is a sufficient amount of electrolyte fluid in said cell for proper operation of said storage battery, wherein the appearance of said top end of the rod indicates to a user of the vent cap whether or not there is sufficient electrolyte in said cell when said vent cap is being used on top of said electrochemical battery.

3. A vent cap according to claim 1 wherein said cap body also defines an initial cooling chamber located above said inlet aperture and an end chamber where said vent hole is located, and said material holding chamber is located between said initial cooling chamber and said end chamber.

4. A vent cap according to claim 3 including a sponge filter mounted in said end chamber so that gases entering said end chamber during use of said vent cap are required to pass through and be filtered by said sponge filter before they can exit through said vent hole.

5. A vent cap according to claim 1 wherein said acid-resisting material is a plurality of small plastic beads substantially filling said material holding chamber.

6. A vent cap according to claim 1 wherein the height of the cap body is such that the cap body projects above the main top surface of said battery no more than 30 mm during use of the vent cap.

7. A vent cap according to claim 6 wherein a section of said bottom located below the material holding chamber slopes downwardly in the direction of said inlet aperture so that, during use of said vent cap, liquid formed by condensation of said vapors on said acid-resisting material is able to flow to said inlet aperture and back into the battery.

8. A vent cap according to claim 1 wherein said connector includes a cylindrical section joined to the bottom of said cap body at said inlet aperture and bayonet connecting flanges on an outer surface of the cylindrical section, and wherein a washer is mounted on said connector for sealing a joint between said top surface of the battery and said connector.

9. A vent cap according to claim 1 wherein said cap body is formed by a main body section providing said bottom and said sidewalls and a top section providing said top wall and connected to said main body section, and wherein said connector includes a cylindrical, downward extension of said main body section located below said inlet aperture.

10. A vent cap according to claim 9 wherein said top section includes a flat top panel and downwardly extending wall sections joined to said top panel, and said top panel, said wall sections, and said bottom together define said material holding chamber.

11. A vent cap for mounting on an electrochemical battery, said vent cap comprising:
a low-profile, hollow cap body including a top wall and a bottom wall, forming a material holding chamber, and having an inlet aperture formed adjacent one end of said bottom wall and a vent hole spaced away from said inlet aperture;
connector means for mounting said cap body on top of said battery at a fill opening of said battery, said connector means providing a fluid passage for fluid flow between an interior of said cap body and said battery by means of said inlet aperture; and
a body of acid-resisting material arranged in said material holding chamber and having a surface area on which vapors from said battery can condense to a liquid as they cool during use of the vent cap,
wherein said cap body in use projects horizontally on one side of said fill opening a substantially greater distance than the cap body projects on the opposite side of said fill opening, said material holding chamber is located above and to said one side of the fill opening, and condensed liquid formed in said material holding chamber during use of the vent cap is able to drain out of said cap body through said inlet aperture.

12. A vent cap according to claim 11 including a light transmitting sight member mounted in said cap body and extending through said inlet aperture and said fluid passage, said sight member having a top end that is visible to a user when said vent cap is mounted on top of said battery and having a lower end that is arranged to project into electrolyte liquid in a cell of said battery during use of said vent cap provided there is a predetermined minimum amount of the electrolyte liquid in said cell.

13. A vent cap according to claim 12 wherein said interior of the cap body is divided into chambers including an initial cooling chamber located above said inlet aperture, said material holding chamber located on one side of the cooling chamber, and an outer end chamber where said vent hole is located, and wherein a vapor filtering member is located in said outer end chamber and covers said vent hole.

14. A vent cap according to claim 12 wherein said body of acid-resisting material comprises a plurality of plastic beads substantially filling said material holding chamber.

15. A vent cap according to claim 12 wherein when said vent cap is mounted on top of said battery, a top surface of the cap body formed by said top wall is located no more than 30 mm above said top of the battery.

16. A vent cap according to claim 15 wherein said connector means includes a cylindrical member connected to said bottom wall of the cap body and bayonet connecting flanges on an outer surface of the cylindrical member, and wherein a washer is mounted on said cylindrical member for sealing a joint between the top of said battery and the cylindrical member.

17. A combination sight glass and vent cap device for use on an electrochemical battery, said device combination comprising:
a cap body having a top and a bottom and forming a material holding chamber, an inlet aperture being formed in said bottom, and a vent hole being provided in said cap body to allow gas to exit from the cap body;
connector means for mounting said cap body on top of said battery at a fill opening of said battery, said connector means providing a fluid passage for fluid flow between an interior of said cap body and said battery by means of said inlet aperture;
a body of acid-resisting material arranged in said holding chamber to provide a surface area on which vapors from said battery can condense as they cool during use of the device; and
a light transmitting sight member mounted in said cap body and extending through said inlet aperture and said fluid passage, said sight member having a top end that is visible to a user when said vent cap is mounted on top of said battery and having a lower end arranged and adapted to project into electrolyte liquid in a cell of said battery during use of said device provided there is a predetermined minimum amount of the electrolyte liquid in said cell.

18. A combination sight glass and vent cap device according to claim 17 wherein, when said device is mounted on said battery, said cap body projects above an adjacent top surface of said battery a distance of no more than 30 mm, said sight member extends downwardly into a fill opening of the battery, and said cap body projects horizontally from one side of said fill opening a substantially greater distance than the cap body projects horizontally from an opposite side of said fill opening.

19. A combination sight glass and vent cap device according to claim 18 wherein said cap body is formed by a lower body section forming said bottom and sidewalls and by a top section forming said top which is flat, said top section being connected to said lower body section, and wherein a top portion of said sight member is mounted in said top section of the cap body.

20. A combination sight glass and vent cap device according to claim 18 including a vapor filtering member mounted in said cap body and covering said vent hole whereby only dry gas exits through said vent hole during use of the battery with said device.
